(19) United States
(12) Patent Application Publication
(10) Pub. No.: US 2010/0326483 A1
(43) Pub. Date: Dec. 30, 2010

(54) Expulsion apparatus

(76) Inventor: Anton Jaeger, Senden (DE)

Correspondence Address: GIFFORD, KRASS, SPRINKLE,ANDERSON & CITKOWSKI, P.C, PO BOX 7021, TROY, MI, 48007-7021, US

(21) Appl. No.: 12/823,460

(22) Filed: Jun. 25, 2010

(30) Foreign Application Priority Data
Jun. 29, 2009 (DE) DE 10 2009 030 96

(51) Int. Cl. B08B 3/00

(52) U.S. Cl. 134/198

(57) ABSTRACT

An expulsion apparatus for a cleaning fluid or treatment fluid, in particular a lance for a high-pressure cleaner, includes a fluid feed line at whose one end a head piece is connected pivotably about a pivot axis and setting means for the changing of the fluid throughflow rate through the head piece, wherein the head piece and the setting means are coupled such that the fluid throughflow rate through the head piece varies in dependence on the set pivot angle between the fluid feed line and the head piece.

The invention relates to an expulsion apparatus for a cleaning fluid or treatment fluid, in particular a lance of a high-pressure cleaner, having a fluid feed line at whose one end a head piece is pivotably connected about a pivot axis.

Such expulsion apparatus are generally known, in particular in the form of so-called lances, which the user holds at its end facing him with one hand or with both hands and which are provided at their fee working ends with a nozzle head. It is already known, for example from DE 2 304 738 A1 or DE 10 2005 042 503 A1, to couple the nozzle head with an adjustment device to adjust the direction of expulsion of the fluid jet relative to the longitudinal axis of the lance.

Lances of this type with a pivotable nozzle head can be used in a variety of applications. The user can thus, for example, clean eaves gutters with a downwardly pivoted nozzle head or the underbody of a vehicle with an upwardly pivoted nozzle head without having to turn the lance itself in so doing.

The fluid being discharged from the nozzle head in this respect causes a recoil which has to be taken up by the user. Whereas this is not a problem with a nozzle head position in which the direction of expulsion coincides with the longitudinal axis of the lance, a tilting moment arises transversely to the longitudinal axis of the lance with an angled nozzle head and has to be taken up by the user by a counter-force which is the larger, the further the nozzle head is away from the position at which the user is holding the lance. Such a behavior of the lance in particular also means a safety problem at high fluid pressures.

It is the object of the present invention to further develop an expulsion apparatus of the initially named kind such that the handling of the apparatus is made possible simply and without excessive use of force by the user.

This object is satisfied by the features of claim 1 and in particular by an expulsion apparatus for a cleaning fluid or treatment fluid, in particular a lance for a high-pressure cleaner, having a fluid feed line at whose one end a head piece is connected pivotably about a pivot axis and having setting means for the changing of the fluid throughflow rate through the head piece, wherein the head piece and the setting means are coupled such that the fluid throughflow rate through the head piece varies in dependence on the set pivot angle between the fluid feed line and the head piece.

The variation of the fluid throughflow rate sensibly takes place such that it is at a maximum when the direction of expulsion of the cleaning fluid or treatment fluid coincides with a longitudinal axis of the expulsion apparatus and is restricted as the angle between the direction of expulsion and the longitudinal axis increases. The total recoil and thus also the magnitude of THAT recoil component which acts perpendicular to the longitudinal axis of the expulsion apparatus and generates the tilting moment on the expulsion apparatus to be compensated by the user. In this respect, the fluid throughflow rate is adopted solely on the basis of a pivoting of the head piece without any additional actuation steps by the user being necessary. The full fluid throughflow rate is in particular automatically available again on a pivoting into an end position in which the direction of expulsion coincides with the longitudinal axis of the expulsion apparatus. The invention thus represents an automatic safety function by which the recoil is restricted the more, the more potentially critical the pivot angle is.

In accordance with an advantageous embodiment, the setting means include a joint which can be flowed through by the fluid and which is made such that the fluid throughflow rate through the joint varies in dependence on the pivot angle. A forced control of the fluid throughflow rate is hereby achieved in a particularly simple manner in dependence on the pivot angle.

In accordance with a preferred embodiment, a ring passage is formed in the joint, with said ring passage in particular extending concentrically to the pivot axis, with an inlet passage communicating with the fluid feed opening into it and with an outlet passage belonging or leading to the head piece starting from it. It can thereby be ensured that a minimal quantity of fluid always arrives at the head piece from the fluid feed line.

In accordance with a further advantageous embodiment, the inlet passage and the outlet passage communicate with one another only via the ring passage in dependence on the pivot angle or are disposed opposite one another with a varying degree of overlap. When the inlet passage and the outlet passage are disposed opposite one another, the fluid moves in a direct path, that is without a deviation via the ring passage, from the fluid feed into the head piece so that a high fluid throughflow rate is achieved in this position.

In a preferred embodiment, the setting means include an adjustable restrictor arranged at the fluid feed line. This effects, alternatively or additionally to the joint, a variation of the fluid throughflow rate in dependence on the pivot angle.

Further preferred embodiments of the invention are set forth in the dependent claims, in the description and in the drawing.

The invention will be described in the following by way of example with reference to the drawing. There are shown:

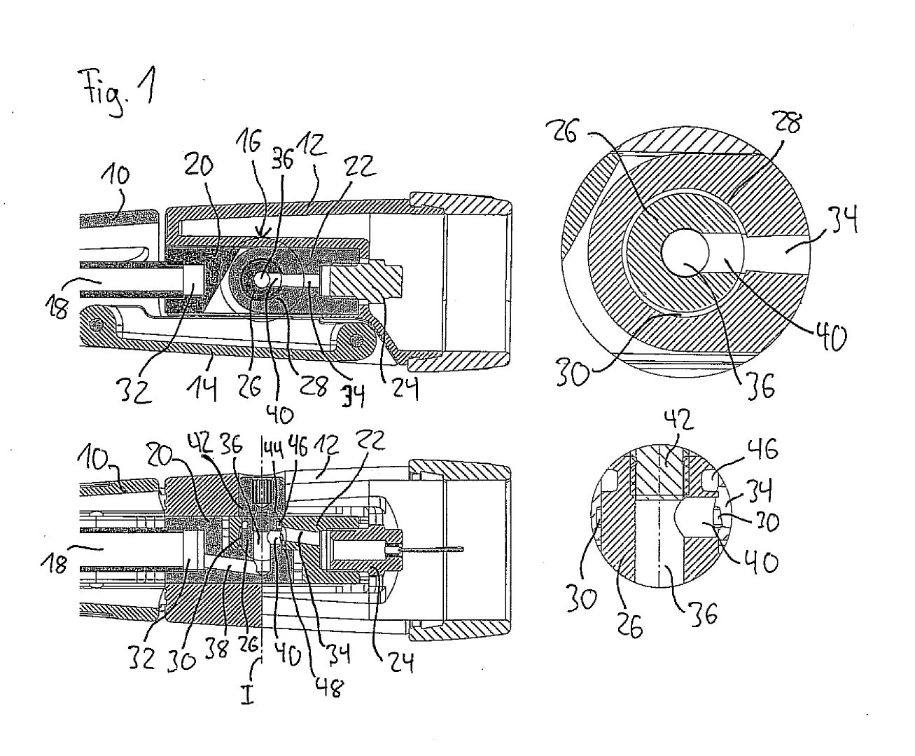

FIG. 1 different sectional views of an embodiment of an expulsion apparatus in accordance with the invention in a first adjustment position;

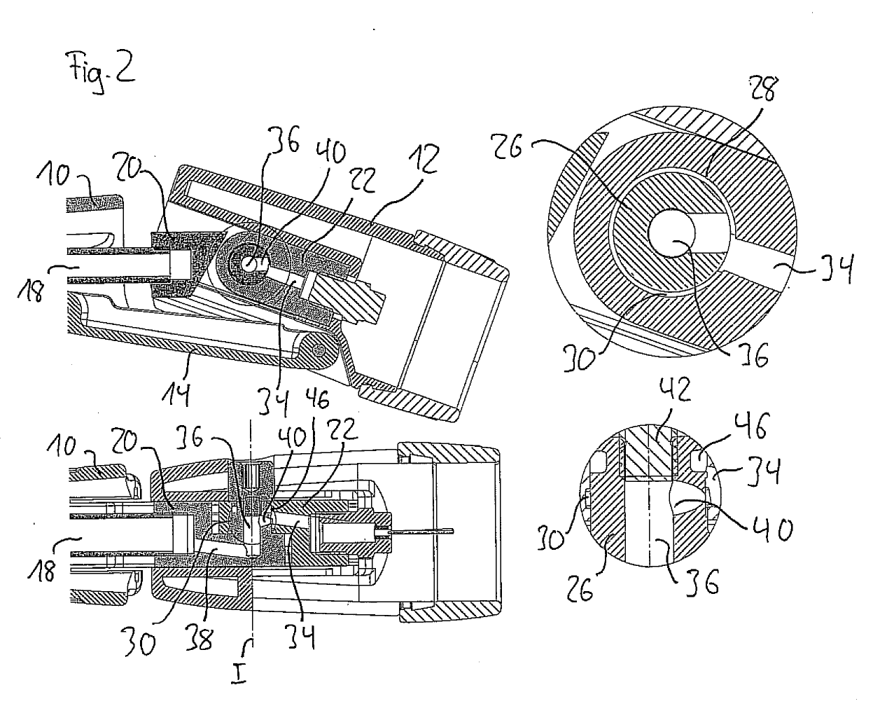

FIG. 2 different sectional views of the embodiment in a second adjustment position;

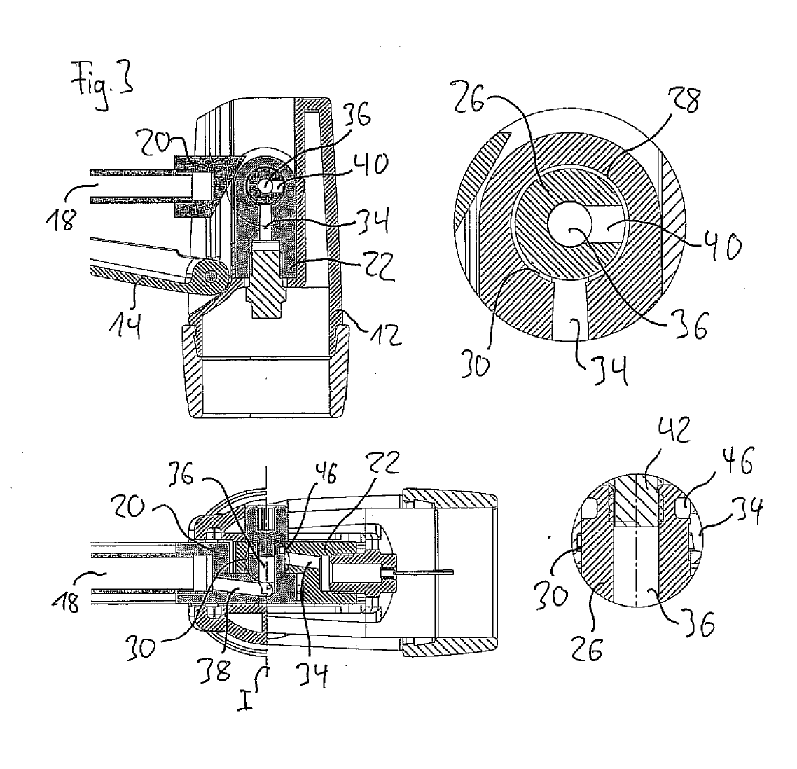

FIG. 3 different sectional views of the embodiment in a third adjustment position;

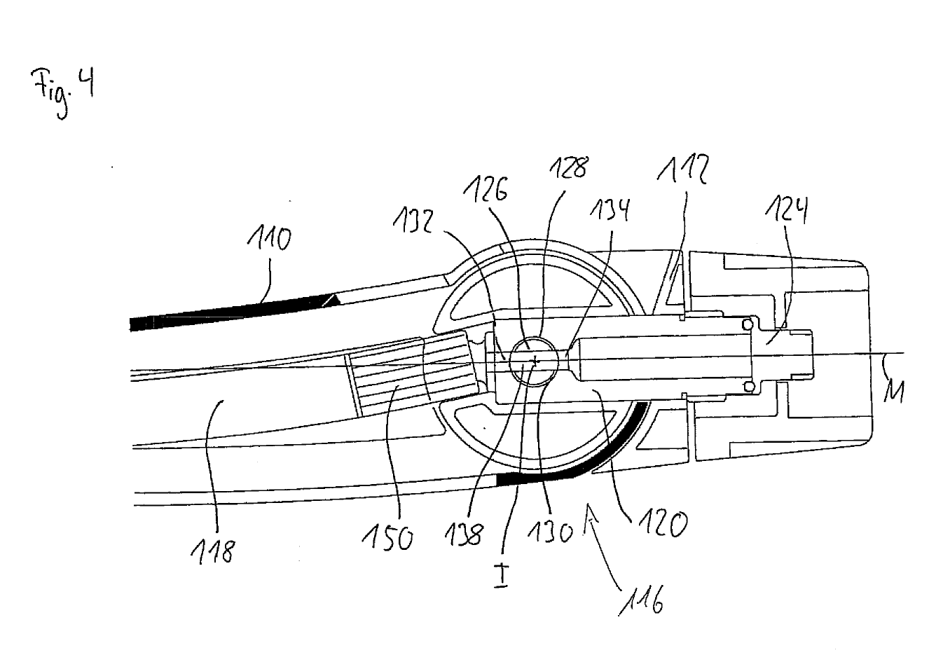

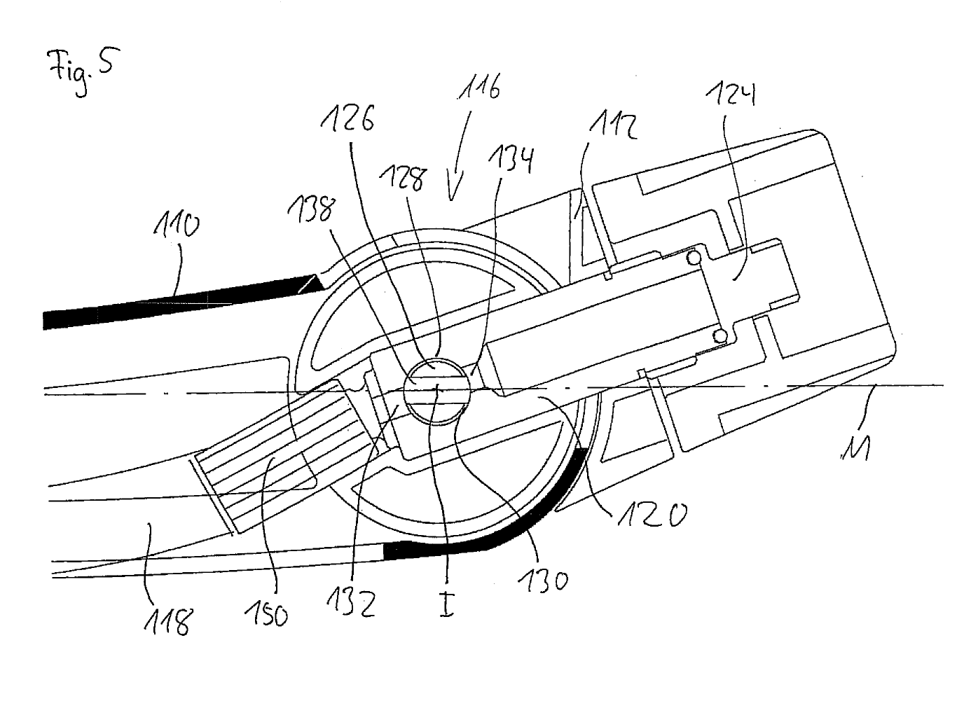

FIGS. 4 and 5 sectional views of a second embodiment in different adjustment positions; and

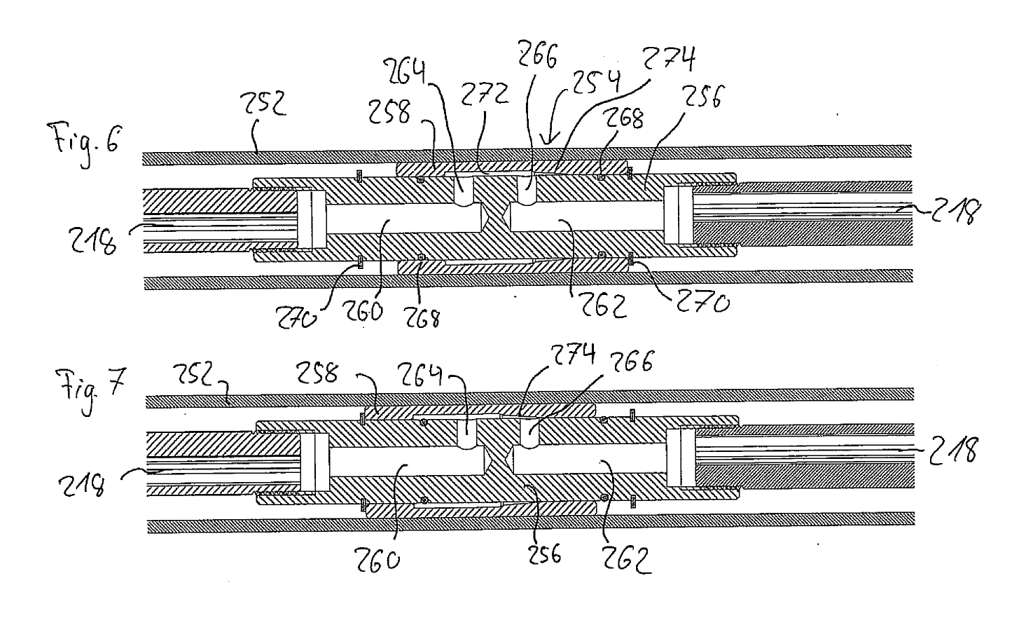

FIGS. 6 and 7 sectional views of a third embodiment in different adjustment positions.

The expulsion apparatus in accordance with the invention are in particular so-called lances for high-pressure cleaning systems. At their ends, not shown, facing the user, these lances have an operating part, made, for example, in the form of a pistol handle, with which the supply of the cleaning fluid to the head piece of the lance can be released or interrupted. For this purpose, the lance is connected to a feed line provided e.g. as a hose in the region of this operating part.

The expulsion apparatus in accordance with the invention in accordance with the first embodiment (FIGS. 1 to 3) includes a carrier 10 at whose end disposed opposite the operating part a head piece 12 is pivotably arranged via a joint piece 16 which is flowed through by fluid and which forms a joint. The pivoting takes place via a pivot lever 14, wherein the actuation of this pivot lever 14 is not the subject of the present invention so that it will not be looked at in any more detail here.

A fluid feed line 18 is conducted in the carrier 10 for the supply of the cleaning fluid or treatment fluid and opens into the joint piece 16. The joint piece 16 includes a first pivot part 20 which is flowed through by fluid and which is connected to the end of the fluid feed line 18. The first pivot part 20 can additionally also be connected to the carrier 10 to achieve a greater stability, for example.

The joint piece 16 furthermore includes a second pivot part 22 which is likewise flowed through by fluid and which is received in the head piece 12. The fluid moves from the fluid feed line 18 via the first pivot part 20 and the second pivot part 22 to a nozzle member 24 which is connected to the second pivot part 22, screwed into it here.

The first pivot part 20 has a hollow spigot 26 which is flowed through by fluid and which is received in an axial bore 28 of the second pivot part 22. The central axes of the hollow spigot 26 or of the axial bore 28 defined in their direction of extent a pivot axis I of the joint piece 16.

The first pivot part 20 has an inlet passage 32 which forms, together with an outlet passage 34 in the second pivot part 22, the flow path for the fluid from the fluid feed line 18 to the nozzle member 34.

The inlet passage 32 includes a transverse passage 38 and a further transverse passage 40 perpendicular to the pivot axis I which extend perpendicular to the pivot axis I and open at positions spaced apart along the pivot axis I into a passage section 36 formed in the hollow spigot 26 and extending coaxially to the pivot axis I.

A ring passage 30 is provided between the hollow spigot 26 and the axial bore 28 and extends concentrically to the pivot axis I in the region of the transverse passage 40. The ring passage 30 is made in the embodiment of FIGS. 1 to 3 as a ring-shaped cut-out in the wall of the axial bore 28 of the second pivot part 22, with it also being possible to provide, alternatively or additionally, a corresponding cut-out in the outer wall of the hollow spigot 26.

As can in particular be recognized in the detail enlargements on the right hand side of FIG. 1, both the transverse passage 40 of the inlet passage 32 and the outlet passage 34 open into the ring passage 30.

A securing bolt 43 having a bolt head is provided for the mutual axial fixing of the two pivot parts 20, 22 and its diameter is somewhat larger than the diameter of the hollow spigot 26. An external thread of the securing bolt 42 is screwed into a corresponding internal thread of the passage section 36. O-rings 44, 46, 48 are provided for sealing.

In the adjustment position shown in FIG. 1, the pivot angle between the carrier 10 and the head piece 12 amounts to 0°. That angle is here understood as a pivot angle of 0° at which the direction of expulsion of the fluid from the head piece 12, on the one hand, and the central axis of the fluid feed line 18 or the central axis of the carrier 10 extend parallel to one another rand in particular coincide.

As can be recognized in the upper part of FIG. 1, the inlet passage 32 and the outlet passage 24 are disposed opposite one another with a maximum degree of overlap. The fluid can therefore flow in a direct path, i.e. without a deviation via the ring passage 30, from the transverse passage 40 into the outlet passage 34.

In the adjustment position shown in FIG. 2, the pivot angle amounts to approximately 20°. As can be recognized in the upper part of FIG. 2, the transverse passage 40 and the outlet passage 34 are now only disposed opposite one another with a reduced degree of overlap. A portion of the fluid flowing out of the transverse passage 40 is therefore incident onto the wall of the axial bore 28, whereas another portion can flow directly from the transverse passage 40 into the outlet passage 34. The flow cross-section is reduced by the reduced degree of overlap between the inlet passage 32 and the outlet passage 34 with respect to FIG. 1 so that the fluid throughflow rate is correspondingly restricted by the joint piece 16.

In the adjustment position shown in FIG. 3, the pivot angle now amounts to 90°. As can be recognized in the upper part of FIG. 3, there is now no longer any overlap at all between the transverse passage 40 of the inlet passage 32 and the outlet passage 34. The fluid flowing out of the transverse passage 40 can reach the outlet passage 34 only via the ring passage 30. The fluid throughflow rate through the joint piece 16 is thereby restricted even further.

The cross-sections of the inlet passage 32, of the outlet passage 34 and of the ring passage 30 are in this respect selected such that, in the adjustment position in accordance with FIG. 1 (pivot angle 0°), a maximum fluid throughflow rate is achieved; in the adjustment position in accordance with FIG. 2 (pivot angle 20°), a fluid throughflow rate restricted with respect to FIG. 1 is achieved; and, in the adjustment position in accordance with FIG. 3 (pivot angle 90°), a minimal fluid throughflow rate restricted even further with respect to the adjustment of FIG. 2 is achieved. The tilting moment which acts transversely to the longitudinal axis of the carrier 10 thereby reduces so that the effort of force is reduced which the user has to exert to hold the expulsion apparatus in the desired working position. It is understood in this respect that the cross-sections are matched to one another such that a sufficient cleaning effect of the fluid flowing out is also ensured with a maximum restriction of the fluid throughflow rate.

A second embodiment of an expulsion apparatus in accordance with the invention having an alternative embodiment of the joint will be described in the following with reference to FIGS. 4 and 5.

The expulsion apparatus includes an elongate carrier 110 which is only shown in an end section, which is made as a hollow body and at whose one end a head piece 112 is fastened which is pivotable about a pivot axis 1 by actuation means not shown in any more detail. A nozzle member 124 is provided at the head piece 112 and the fluid is expelled from the expulsion apparatus through it. The construction of the head piece 112 will be explained in more detail in the following.

A fluid feed line 118 is arranged in the interior of the carrier 110 which is ductile or flexible in at least one end region at the head piece side and which is connected via a connection piece 150 to the head piece 112.

The head piece 112 includes a pivot part 120 having a rectangular cross-section which has an axial bore 128 in which a pivot pin 126 arranged at the carrier 110 is received. The pivot part 120 and the pivot pin 126 form a joint 116 for the head piece 112, with the central axis of the pivot pin 126 defining the pivot axis I. A flow path for the fluid is formed in the interior of the pivot part 120, with said flow part communicating, on the one hand, via the connection piece 150 with the fluid feed line 118 and, on the other hand, with the nozzle member 124.

The flow path includes an inlet passage 132 and an outlet passage 134. To enable fluid communication, the pivot pin 126 is provided with a transverse passage 138 which is formed as a radial bore and which extends in the direction of a central axis M of the carrier. With a pivot angle of 0° (FIG. 4), the openings of the transverse passage 138 and the openings of the inlet passage and outlet passage 132, 134 are disposed opposite one another so that the fluid can flow directly from the passage 132 through the passage 138 into the passage 134.

A portion of the fluid flows through a ring passage 130 formed concentrically to the pivot pin 126 in the region of the openings of the passages 132, 138, 134 with the cross-sections of the ring passage 130, of the transverse passage 138 and of the inlet passage and outlet passage 132, 134 being selected so that the fluid throughflow rate through the ring passage 130 is smaller than the fluid throughflow rate flowing through the transverse passage 138 at a pivot angle of 0°. In the adjustment position in accordance with FIG. 4, a maximum fluid throughflow rate is given by the pivot part 120.

In the adjustment position in accordance with FIG. 5 at a pivot angle of approximately 20°, the openings of the radial bore 138 and of the inlet passage and outlet passage 132, 124 only overlap partly so that a smaller quantity of fluid flows through the passages 132, 138 than at a pivot angle of 0° and the total fluid throughflow rate is thus restricted.

The pivot pin 126 and thus the orientation of the passage 138 can be adjustable relative to the carrier 110 in order thus to be able to adjust the dependence of the restriction effect on the pivot angle.

An automatic reduction of the recoil movement acting transversely to the central axis M of the lance in dependence on the pivot angle is also achieved in this embodiment by the reduction in the expulsion quantity in dependence on the pivot angle.

The expulsion apparatus in accordance with the invention in accordance with the third embodiment, of which only a part section is shown in FIGS. 6 and 7, includes a head piece which is not shown and which is pivotably arranged with respect to a fluid feed line 218. The head piece is pivotable about a joint which is likewise not shown.

Similar to the first or second embodiments, the joint piece can have a leadthrough for the fluid, wherein the means for the restriction of the fluid throughflow rate described with respect to FIGS. 1 to 5 can, but do not have to, be omitted.

Alternatively, the joint can also be made without a fluid leadthrough, with the fluid feed line 218 then preferably being made flexible at least in the region of the joint.

An actuation apparatus 252 is provided for the pivoting of the head piece which is arranged coaxial to the fluid feed line 218 and is displaceable axially to it. The head piece is coupled in a suitable manner with the actuation apparatus 252, for example by means of a pivot lever similar to the pivot lever 14 of FIGS. 1 to 3, for the conversion of the axial movement into a pivot movement of the head piece.

A restrictor 254 is introduced into the fluid feed line 218 and has an elongate base body 256 connected to the fluid feed line 218 and a slider 258 axially displaceable to the base body 256 and connected to the inner side of the actuation apparatus 252.

Two chambers 260, 262 made as blind bores introduced in each case at the end face are provided in the base body. Two radial bores 264, 266 which each open into one of the chambers 260, 262 are provided in the region of the periphery of the base body 256.

The slider 258 which is provided with a cut-out 272 at its inner periphery, is arranged coaxially to the base body 256 and is sealed via O-rings 268 with respect to it. Abutments 270 bound the displacement path of the slider 258. The cut-out 272 engages over both radial bores 264, 266 in every adjustment position.

A chamfer 274 is provided at an end of the cut-out 272 so that the cross-section of the cut-out 272 is continuously reduced in the axial direction.

The fluid can move from the one chamber 260 via the radial bore 264, the cut-out 272 and the radial bore 266 into the other chamber 262. The flow path can naturally also extend in the reverse direction in dependence on the installation direction of the restrictor with respect to the direction of flow of the fluid. The cut-out 272, together with the radial bores 264, 266, forms an overflow passage for the fluid between the two chambers 260, 262.

In the adjustment position in accordance with FIG. 6, both radial bores 264, 266 are covered by a region of the cut-out 272 in which its cross-section is at a maximum. The chamfer 274 is located outside the flow path. The fluid throughflow rate is therefore at a maximum. In this adjustment position, the pivot angle of the head piece preferably amounts to 0°, i.e. the expulsion of the fluid takes place in the longitudinal direction of the lance.

If the actuation apparatus 252 is displaced axially to the fluid feed line 218 to adjust the head piece into an angular position different from 0°, the slider 258 necessarily also moves into an adjustment position in accordance with FIG. 7. In this respect, the chamfer 274 is displaced into the region of the radial bore 266 so that as a consequence thereof the cross-section of the flow path between the chambers 260, 262, and thus also the fluid throughflow rate to the head piece, reduces continuously in dependence on the displacement path and thus on the angular position of the head piece.

The dependence of the fluid throughflow rate on the pivot angle can generally be preset as desired by the extent of the chamfer 274.

### REFERENCE NUMERAL LIST

10, 110 carrier
12, 120 head piece
14 pivot lever
16 joint piece
18, 118, 218 fluid feed line
20, 120 first pivot part
22 second pivot part
24, 124 nozzle member
26, 126 hollow spigot
28, 128 axial bore
30, 130 ring passage
32, 132 inlet passage
34, 134 outlet passage
36 passage section
38, 138 transverse passage
40 transverse passage
42 securing bolt
44 O-ring
46 O-ring
48 O-ring
150 connection piece
252 actuation apparatus
254 restrictor
256 base body
258 slider
260, 262 chamber
264, 266 radial bore
268 O-ring
270 abutment
272 cut-out
274 chamfer
I pivot axis
M central axis

1. An expulsion apparatus for a cleaning fluid or treatment fluid,
in particular a lance for high-pressure cleaners, having
a fluid feed line (18, 118, 218) at whose one end a head piece (12, 112) is connected pivotably about a pivot axis (I); and
setting means (16, 116, 254) for the changing of the fluid throughflow rate through the head piece (12, 112),
wherein the head piece (12, 112) and the setting means (16, 116, 254) are coupled such that the fluid throughflow rate through the head piece (12, 112) varies in dependence on the set pivot angle between the fluid feed line (18, 118) and the head piece (12, 112).

2. An expulsion apparatus according to claim 1, characterized in that the setting means are made such that an actuation movement of the head piece (12, 112) and/or the pivot movement of the head piece (12, 112) varies the fluid throughflow rate.

3. An expulsion apparatus according to claim 1, characterized in that the setting means include a joint (16, 116) through which the fluid can flow and which is made such that the fluid throughflow rate through the joint (16, 116) varies in dependence on the pivot angle.

4. An expulsion apparatus according to claim 1, characterized in that at least one flow path for the fluid is formed in the joint (16), with the flow cross-section of the flow path varying in dependence on the pivot angle.

5. An expulsion apparatus according to claim 1, characterized in that the joint (16) includes a first pivot part (20) and a second pivot part (22) which are pivotably connected to one another about the pivot axis (I), with in particular the fluid feed line (18) being connected to the first pivot part (20) and with the head part (12) being connected to the second pivot part (22).

6. An expulsion apparatus according to claim 5, characterized in that the first pivot part (20) has a spigot (26) which is received in an axial bore (28) of the second pivot part (22), with the pivot axis (I) being defined by the direction of extent of the spigot (26) and of the axial bore (28).

7. An expulsion apparatus according to claim 6, characterized in that the spigot of the first pivot part (20) is a hollow spigot (26) which can be flowed through by the fluid.

8. An expulsion apparatus according to claim 1, characterized in that a ring passage (30), in particular a ring passage extending concentrically to the pivot axis, is formed in the joint (16), into which ring passage at least one inlet passage (32) communicating with the fluid feed line (18) opens and from which at least one outlet passage (34) belonging to or leading to the head piece (12) starts.

9. An expulsion apparatus according to claim 8, characterized in that the flow path from the fluid feed line (18) to the ring passage (30) includes passage section (36) whose central axis coincides with the pivot axis (I).

10. An expulsion apparatus according to claim 8, characterized in that the passage section (36) communicates both with the ring passage (30) and with the fluid feed line (18) in each case via a transverse passage (38, 40), with the transverse passages (38, 40) opening into the passage section (36) at positions spaced apart along the pivot axis.

11. An expulsion apparatus according to claim 8, characterized in that the ring passage (30) is formed between a hollow spigot (26) of a first pivot part (20) and an axial bore (28) of a second pivot part (22).

12. An expulsion apparatus according to claim 8, characterized in that the inlet passage (32) and the outlet passage (34) communicate with one another only via the ring passage (30) in dependence on the pivot angle or are disposed opposite one another with varying degrees of overlap.

13. An expulsion apparatus according to claim 8, characterized in that the cross-sections of the inlet passage (32), of the outlet passage (34) and of the ring passage (30) are selected such that the fluid throughflow rate is at a maximum when the inlet passage (32) and the outlet passage (34) are disposed opposite one another with a maximum degree of overlap.

14. An expulsion apparatus according to claim 8, characterized in that the inlet passage (32) and the outlet passage (34) are disposed opposite one another at a pivot angle of 0° with a maximum degree of overlap at which the direction of extent of the fluid feed line (18) at least in the region of the head piece (12) and the direction of expulsion of the fluid from the head piece (12) coincide at least substantially.

15. An expulsion apparatus according to claim 1, characterized in that the setting means include an adjustable restrictor (254) arranged at the fluid feed line (218).

16. An expulsion apparatus according to claim 15, characterized in that the restrictor (254) is coupled to an actuation apparatus (252) which is preferably displaceable axially to the fluid feed line (218) for the pivoting of the head piece.

17. An expulsion apparatus according to claim 15, characterized in that the restrictor (254) includes a base body (256) which is arranged in the fluid feed line (218) and in which two chambers (260, 262) are formed which are in fluid communication via an overflow passage (264, 266, 272) with a variable cross-section.

18. An expulsion apparatus according to claim 17, characterized in that the restrictor (254) has an axially displaceable slider (256) which is in particular arranged coaxially to the base body (256) and in which the overflow passage is foamed whose cross-section decisive for the fluid communication is determined by the changeable axial position of the slider (256).
